(19) United States
(12) Patent Application Publication
(10) Pub. No.: US 2010/0129281 A1
(43) Pub. Date: May 27, 2010

(54) A PROCESS FOR THE RECYCLING OF HIGH PURITY SILICON METAL

(76) Inventors: Per Bakke, Porsgrunn (NO); Robert Gibala, Skien (NO); Jorild Margrete Svalestuen, Porsgrunn (NO); Grete Viddal Øi, Porsgrunn (NO)

Correspondence Address: WENDEROTH, LIND & PONACK, L.L.P., 1030 15th Street, N.W.,, Suite 400 East, Washington, DC, 20005-1503, US

(21) Appl. No.: 12/597,078

(22) PCT Filed: Apr. 18, 2008
(86) PCT No.: PCT/NO08/00141

§ 371 Date: Jan. 11, 2010

(30) Foreign Application Priority Data
Apr. 25, 2007 (NO) 20072147

(51) Int. Cl. C01B 33/08

(52) U.S. Cl. 423/341

(57) ABSTRACT

A process for the re-use of remainders or other residual Si of high purity silicon such as saw dust or kerf from manufacturing of solar cells wafers or semi-conductor devices, is characterized in that the dry kerf, chips and/or other residual Si from wafer production processes or semi-conductor devices is used as feedstock together with metallurgical grade silicon in a direct chlorination reactor (1) producing silicon tetrachloride, SiCl₄. Unreacted kerf or other small particles that escape the reaction zone unreacted are repeatedly returned to the reactor for further chlorination regardless of their size. The equipment included in the process may, beyond the reactor (1), comprise a storage and mixing device (2) for the mixing and storage of the Si material/kerf, a recovery device (3) for separation and recovery of Si containing particles escaping the reaction zone of the reactor and being returned to the reaction zone of the reactor by a return feeding means (9), a condensation unit (10) in which the smallest sized particles escaping the reaction zone of the reactor and recovery device are collected in a slurry with the liquid SiCl₄, and a mixing unit (13) into which additional kerf, chips and other residual Si from wafer production processes or semi-conductor devices is added and mixed with the existing SiCl₄/Si slurry that is subsequently added directly to the reaction zone of the reactor for cooling and temperature control.

The present invention relates to a process for the recycling or re-use of remaining metal (remnants of metal) of high purity silicon in particular saw dust (kerf or swarf) from manufacturing solar cells or semiconductor devices.

In the production of silicon wafers for the photovoltaic industry a wire saw cutting process is employed to slice the mono or polycrystalline ingots into wafers. The cutting process produces a large quantity of sawdust (kerf). Depending on the wafer thickness and the diameter of the cutting wire, the amount of sawing chips may add up to 30-50% of the ingot weight (kerf loss). Due to the contact with the cutting wire and the cutting liquid, the quality of the sawing chips recovered after separation form the wire saw slurry is deteriorated compared to the Si ingot from where the chips and fillings originated. As a result, the chips cannot be remelted and cast into crystalline Si ingots as this would lead to contamination by certain elements like for example Fe and particulate material such as SiC that is added to the cutting fluid. Various processes have been proposed to utilize the recovered crystalline silicon kerf within the solar silicon industry as for example by sintering into thin-layer PV cell configurations as described in U.S. Pat. No. 6,780,665.

The major fraction of the particles of the kerf may be significantly smaller than 100 micrometer. Hence, when using a fluid bed reactor for producing silicon tetrachloride, small particles will mainly escape from a fluid bed reactor un-reacted if the feedstock is introduced in a conventional manner. SiC particles that may or may not be separated from the kerf, may be chlorinated in an excess of Cl₂, forming SiCl₄ and CCl₄. If not, these particles will accumulate in the reactor or escape depending on their size. Iron particles from the kerf will be chlorinated. With the present invention is provided a process and equipment that will overcome the problem with escaping Si particles and contamination of high purity Si with SiC and Fe particles.

EP-A-1 249 453, EP-A-0 784 057 and EP-A-0 900 802 describe methods for reuse of un-reacted fine Si containing particles from fluidized bed reactors. In EP 1 249 453 A un-reacted particles from the synthesis of silane (general formula RₙSiCl₄₋ₙ, where R is hydrogen, methyl or ethyl and n is an integer from 0 to 4) is collected in liquid silane and fed back to the reactor. In EP-A 0 784 057 and EP-A 0 900 802 un-reacted Si containing particles from the synthesis of (alkylhalo)silane (general formula RₙSiCl₄₋ₙ, where R is an alkyl group having 1-4 carbon atoms, X is a halogen atom and n is an integer from 0 to 4) is collected in a cyclone and a filter. By means of a back-flow gas the particles are fed back to the reactor.

Unlike the above processes which handle fine particles or dust generated internally by the process, the present process utilizes an alternative feedstock (kerf) which by definition contains a large fraction of fine particles. Moreover, the present process is, as stated above, also designed to handle contaminants in the silicon kerf such as SiC particles and Fe and/or other metallic impurities. Thus, the present invention represents an innovative process for re-cycling silicon kerf to solar grade silicon quality in a cheap and effective manner via production of silicon tetrachloride in a reactor.

The process according to the invention is characterized by the features as defined in the attached, independent claim 1.

Claims 2-11 define preferred embodiments of the invention.

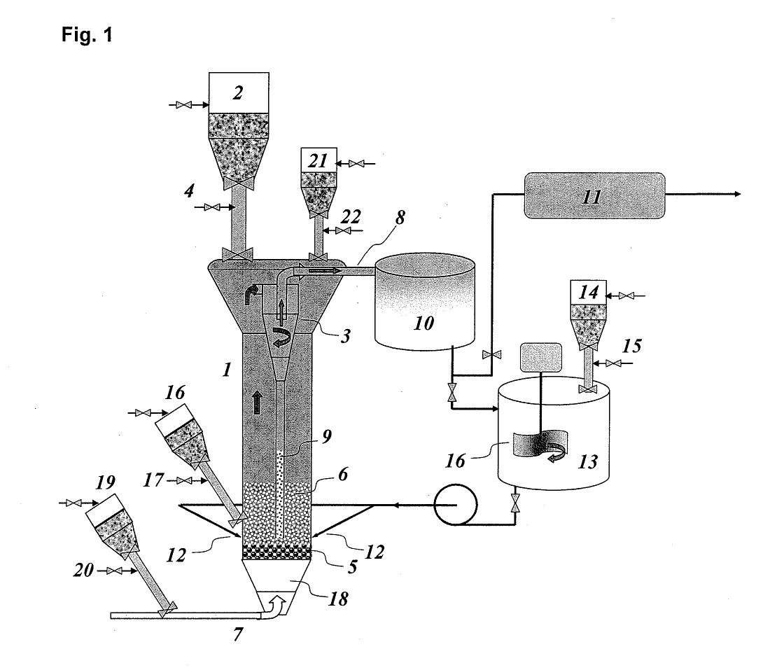

The invention will be further described in the following by way of example and with reference to the attached FIG. 1, which shows a principal sketch of the equipment according to the invention on which the process according to the invention is based.

As is shown in FIG. 1 the equipment includes, in brief, a reactor 1 for the chlorination of Si material, a storage and mixing device or arrangement 2 for Si feedstock, and a Si particle recovery device 3, for example a cyclone placed inside the reactor. Metallurgical Si is supplied to the reactor from the storage device 2 by means of for instance a locker system 4 where an inert gas is used to supply the necessary overpressure during feeding, or a screw feed device. Kerf, chips and other residual Si from wafer production processes or electronic industry of equal size and/or larger than the smallest particles of metallurgical grade Si can be mixed with the metallurgical grade Si in the storage device 2. The reactor, for instance being a fluid bed reactor as shown in FIG. 1, is provided with a sinter material cushion, a perforated plate or a plate with one or several nozzles (nozzle plate) 5 on top of which the Si feedstock 6 is feed. Cl₂ is supplied from a supply source (not shown) to the bottom of the reactor 1 via a supply line 7. The Cl₂ entering through the sinter material cushion, perforated plate or nozzles reacts with the Si and silicon tetrachloride, SiCl₄ produced under this reaction is evacuated from the reactor through an outlet 8 together with Si particles that may be brought with the flow of SiCl₄ out of the reactor. The SiCl₄ with the particles enters from the outlet via a pipeline 8 from the recovery device 3 which may be a filtering or separator device, for instance a cyclone, where the Si particles are separated from the SiCl₄ and immediately returned to the reaction zone through a connecting pipe 9. SiCl₄ flows out of the separator device through a pipeline 8 to a quenching unit 10 where the SiCl₄ gas is condensed. From the quenching unit the liquid SiCl₄ can be transferred through various purification steps 11 such as for example filtration or hydrocyclones (not shown in detail) where in particular, Fe particles from the kerf chlorinated to FeCl₃ is removed before being shipped to consumers or subjected to a reduction process as part of a larger Si production plant. The fraction of the kerf, chips and other remnant Si from wafer production processes or electronic industry consisting of particles which are quite smaller than the metallurgical grade Si being fed to the reactor have to be treated differently. The relatively small sized kerf (large surface to volume ratio) makes this material highly reactive in a direct chlorination process, and if a fluid bed reactor is used, internal cooling may be needed close to the sinter material cushion, perforated plate or nozzle plate 5, for example with SiCl₄ as a cooling medium. This may be done by spraying liquid SiCl₄ directly into the reaction zone through one or several nozzles 12. The fine fraction of the silicon kerf can be added to the liquid SiCl₄ that is to be injected for cooling by creating a slurry in a mixing vessel 13, into which the kerf is added from the storage device 14 by means of for instance a locker or sluice system 15 where an inert gas is used to supply the necessary overpressure during feeding, or through a screw feed device. A mixing device 16 can be used for preparation of homogeneous SiCl₄/Si slurry. Typically, the volume of SiCl₄ injected per unit time for cooling is 4-8 times larger than the volume SiCl₄ produced. Alternatively, or simultaneously, the fine fraction of silicon kerf can be added as particles directly into the reaction zone of the fluidized bed or fixed bed just above the material cushion, perforated plate or nozzle plate 5 pneumatically from a storage device 16 by means of for instance a locker or sluice system system 17. An inert gas is used to transport the particles and to provide the necessary overpressure during feeding. Alternatively, or simultaneously, the fine fraction of the silicon kerf can be added directly to the chlorine gas flow 7 or in the wind box 18 below the material cushion, perforated plate or nozzle plate 5 pneumatically from a storage device 19 by means of a locker or sluice system 20 where an inert gas is used to supply the necessary overpressure during feeding. The Si particles will not react at the low temperature but will be brought with the cold chlorine gas through the material cushion, perforated plate or nozzle plate 5 directly into the hot reaction zone where they immediately are heated sufficiently to react with the chlorine.

An option would also be to press tablets or pellets of the kerf possibly with the use of an organic binder, before introducing them into the reactor. Depending on the mechanical strength of the tablets or pellets these may be added through the existing feeding device for the metallurgical grade Si 2, or through a separate storage device 21 by means of a locker or sluice system 22 where an inert gas is used to supply the necessary overpressure during feeding. Since the tablets or pellets possibly will be larger than the metallurgical grade Si being charged to the fluid bed reactor, the tablets or pellets may end up at the material cushion, perforated plate or nozzle plate 5 causing the bed not to fluidize properly, and as a result, Cl₂ may escape from the reactor without being converted. This may be alleviated by simultaneous addition of a certain fraction of metallurgical grade Si, which may secure the 100% chlorine conversion, fluidization and heat distribution. This is more easily achieved by adding the tablets through a separate storage device 21 and feeding system 22. Nevertheless, if the tablets are significantly larger than the Si particles in the fluidized bed these will end up near the material cushion, perforated plate or nozzle plate close to the chlorine inlets, and as a consequence, the tablets may create a stationary bed rather than a fluidized bed, possibly with poor heat distribution, temperature gradients and local hotspots. Therefore, tablets may not be the preferred method for introducing kerf to the reactor.

Regardless of how the fine fraction of kerf is introduced, a certain amount of Si, SiC and Fe particles are likely to escape the reaction zone and the particle capture device unreacted, and eventually end up in the crude SiCl₄, and hence become reintroduced to the reaction zone through the internal cooling system 12. In situations where accumulation of kerf particles in the crude SiCl₄ has occurred, the feeding of fine sized kerf to the reactor can be temporarily be reduced or halted to facilitate conversion of the kerf in the SiCl₄ that is circulated for cooling.

Another way to increase the conversion of particles in the reactor is to reduce the flow (velocity) of the inlet gas to the system. This would slow down the productivity of the process. Therefore, it is preferred to limit the fraction of small size particles in the process. Depending on the size distribution of the metallurgical grade Si used as feed alongside the kerf, it is recommended to limit the ratio of kerf to metallurgical grade Si in the feed. Furthermore, iron that may be a contaminant in the kerf is chlorinated to iron chlorides, which also accumulate in the reactor partly as a deposit layer on the walls. Higher Fe content in the feed may therefore lead to more frequent stoppages for cleaning of the reactor.

On the other hand, with respect to the content of trace elements, kerf and other residual Si from wafer production processes or electronic industry are normally superior to metallurgical grade Si. Hence bringing in a significant fraction of such material in the feed for the chlorination reactor represents an improvement in the quality of the product. This is especially valid for critical elements like B, P and Al. The content of these elements in metallurgical grade Si may vary between producers and among particle size. Generally, the smaller size the more contaminants. Kerf or other residual high purity Si may thus be mixed with metallurgical Si in a manner so as to stabilize the content of one or more critical elements fed into the reactor.

After purification step(s) possibly including distillation and addition of complexing agents as for example described in patents U.S. Pat. No. 2,812,235 and U.S. Pat. No. 4,282,196, the purified SiCl₄ extracted from the reactor can be reduced with a liquid metal, for example Zn or Mg to produce solar grade Si and a metal chloride, for example as described in patent application No. WO2006/100114 A1. An adjacent process for electrolysis of the metal chloride recovers the chlorine gas for the direct chlorination process, and the metal for the reduction process step. Depending on the purity the silicon tapped from the reduction reactor may be cast directly into crystalline ingots, or cast for subsequent remelting and additional refining such as zone refining before finally cast into crystalline ingots ready for wafer slicing.

The proposed method for recycling sawing chips is especially beneficial for an integrated plant, that is, a plant where the unit processes involving chlorination of Si, purification of SiCl₄, reduction of SiCl₄, ingot casting, ingot slicing (wafer production) and separation of sawing chips from cutting fluid are co-located.

1-11. (canceled)

12. Process for the re-use of remainders or other residual Si of high purity silicon such as saw dust or kerf from manufacturing of solar cells wafers or semi-conductor devices, wherein the dry kerf potentially contaminated with SiC particles and Fe and/or other metal impurities, chips and/or other residual Si from wafer production processes or semi-conductor devices is used as feedstock together with metallurgical grade silicon in a direct chlorination reactor (1) producing silicon tetrachloride, SiCl₄, whereby un-reacted kerf or other small particles that escape the reaction zone un-reacted are captured and repeatedly returned to the reactor for further chlorination regardless of their size.

13. A process in accordance with claim 12, wherein the chlorination is accomplished in a fluidized bed reactor with a material cushion, perforated plate or nozzle plate (5) supporting the reaction zone.

14. A process according to claim 12, wherein the kerf potentially contaminated with SiC particles and Fe and/or other metal impurities, chips and/or other residual Si from wafer production processes or semi-conductor devices of mainly larger than the smallest particles of metallurgical grade Si is mixed with the metallurgical grade Si in a storage device and added to the reactor on a continuous or intermittent basis.

15. A process according to claim 12, wherein the kerf potentially contaminated with SiC particles and Fe and/or other metal impurities, chips and other residual Si from wafer production processes or semi-conductor devices of mainly smaller size than the smallest particles of metallurgical grade Si is added and mixed into liquid SiCl₄ on a continuous or intermittent basis forming a slurry that is subsequently added directly to the reaction zone of the reactor for simultaneous cooling and temperature control.

16. A process according to claim 12, wherein the kerf potentially contaminated with SiC particles and Fe and/or other metal impurities, chips and other residual Si from wafer production processes or semi-conductor devices of mainly smaller size than the smallest particles of metallurgical grade Si is added directly into the hot reaction zone just above the material cushion, perforated plate or nozzle plate (5) on a continuous or intermittent basis.

17. A process according to claim 12, wherein the kerf potentially contaminated with SiC particles and Fe and/or other metal impurities, chips and other residual Si from wafer production processes or semi-conductor devices of mainly smaller size than the smallest particles of metallurgical grade Si is added directly into the cold chlorine gas flow upstream of the material cushion, perforated plate or nozzle plate (5) on a continuous or intermittent basis.

18. A process according to claim 12, wherein the kerf potentially contaminated with SiC particles and Fe and/or other metal impurities, chips and other residual Si from wafer production processes or semi-conductor devices is pressed to tablets or pellets and mixed with the metallurgical grade Si in a storage device (2) and added to the reactor on a continuous or intermittent basis.

19. A process according to claim 12, wherein the kerf potentially contaminated with SiC particles and Fe and/or other metal impurities, chips and other residual Si from wafer production processes or semi-conductor devices is pressed to tablets or pellets and added to the reactor from a separate device (21, 22) on a continuous or intermittent basis.

20. A process in accordance with claim 12, wherein the largest particles escaping the chlorination process are separated from the SiCl₄ by means of a cyclone (3) and returned to the reaction zone by a return feeding means (9).

21. A process in accordance with claim 12, wherein the smallest sized particles escaping the chlorination process and the cyclone follow the SiCl₄ gas to the condensation unit and is subsequently returned to the reaction zone in the form of a slurry with the liquid SiCl₄ that is used for cooling and temperature control.

22. A process in accordance with claim 12, wherein the fraction of the smallest sized particles following the SiCl₄ liquid out of the loop to a liquid/solid separation unit are subsequently separated from the solid chlorides by dissolving the chlorides in water and after drying being returned to the reaction zone.
